(19) United States
(12) Patent Application Publication
(10) Pub. No.: US 2026/0336404 A1
(43) Pub. Date: Oct. 29, 2026

(54) RECREATIONAL VEHICLE WITH DISPLAY HAVING FNR FUNCTIONALITY

(71) Applicant: Textron Inc., Providence, RI (US)

(72) Inventors: Matthew Francis Simms, Augusta, GA (US); Joel Enrique Pabon, North Agusta, SC (US); Mia Sharese Abney, Evans, GA (US)

(73) Assignee: Textron Inc., Providence, RI (US)

(21) Appl. No.: 19/191,532

(22) Filed: Apr. 28, 2025

(51) Int. Cl. B60K 35/28; B60W 30/182; B60W 50/00; B60W 50/08; B60W 50/14

(52) U.S. Cl. CPC B60K 35/28; B60W 30/182; B60W 50/082; B60W 50/14; B60K 2360/11; B60K 2360/1438; B60K 2360/1468; B60K 2360/172; B60K 2360/56; B60K 2360/589; B60W 2050/0083; B60W 2050/146; B60W 2300/405; B60W 2540/215; B60W 2556/45

(57) ABSTRACT

A golf vehicle includes a chassis, a body, tractive elements, a driveline to drive the tractive elements, a display, and a control system. The control system is configured to control the display to provide a graphical user interface including operating modes of the driveline, receives a user input via the display to select a respective operating mode of the driveline, and operates the driveline according to the respective operating mode.

### BACKGROUND

Vehicles typically include a driveline that propels the vehicle. The driveline may have multiple modes of operation to propel the vehicle in various directions.

### SUMMARY

One embodiment relates to a golf vehicle. The golf vehicle includes a chassis, a body coupled to the chassis, a plurality of tractive elements coupled to the chassis, a driveline to drive the tractive elements, a display, and a control system. The control system is configured to operate the display to provide a graphical interface including a plurality of operating modes of the driveline, receive a user input via the display indicative of a selection of a respective operating mode of the driveline, and operate the driveline according to the respective operating mode.

Another embodiment relates to a method for operating a driveline according to user inputs. The method includes providing a graphical interface displaying a plurality of operating modes of the driveline, receiving a user input indicating a selection of a respective operating mode of the driveline, displaying the selection of the respective operating mode, and operating the driveline according to the respective operating mode.

Still another embodiment relates to a recreational vehicle. The recreational vehicle includes a chassis, a body, tractive elements, a driveline, and a display providing a graphical user interface. The graphical user interface includes indicators positioned along an edge of the display providing an indication of the operating modes of the driveline, a moveable graphical control element repositionable between the indicators, a first sub-graphical user interface providing an indication of operating parameters of the vehicle, and a second sub-graphical user interface providing access to one or more applications associated with a user device connected to the recreational vehicle.

Still another embodiment relates to a golf vehicle. The golf vehicle includes a chassis, a body, a plurality of independently operable lights, a display device, and a control system. The control system is configured to acquire information regarding a function of the lights, control the display device to display the information regarding the function of the lights, receive a user input regarding the function of a respective light, and operate the respective light according to the user input.

Still another embodiment relates to a method for operating vehicle lights according to user inputs. The method includes wirelessly coupling with a light of a vehicle, receiving information indicative of a function of the vehicle lights, displaying first graphical control elements used to select a respective light and second graphical control elements used to adjust the function of the vehicle lights, receiving user inputs selecting the respective light and adjusting the function of the respective light, and operating the respective light according to the user inputs.

Still another embodiment relates to a recreational vehicle. The recreational vehicle includes a chassis, a body, lights, and a display device providing a graphical user interface. The graphical user interface includes a first sub-graphical user interface in a first section of the graphical user interface providing first graphical control elements to select a respective light and second graphical control elements to adjust a function of the respective light, and a second sub-graphical user interface in a second section of the graphical user interface providing access to one or more applications associated with a user device connected to the recreational vehicle.

Still another embodiment relates to a golf vehicle. The golf vehicle includes a chassis, a body, a display, and a control system. The control system is configured to wirelessly couple with a user device, acquire information from the user device, acquire information regarding one or more operating parameters of the golf vehicle, and control the display to provide a graphical user interface. The graphical user interface includes a first sub-graphical user interface in a first section of the graphical user interface providing one or more operating parameters of the golf vehicle and allowing a user to adjust settings of the golf vehicle, and a second sub-graphical user interface in a second section of the graphical user interface at the same time as the first sub-graphical user interface providing a user access to one or more applications associated with the user device.

Still another embodiment relates to a method for operating a vehicle according to user inputs. The method includes controlling a display to provide a graphical user interface with a first sub-graphical user interface and a second sub-graphical user interface, wirelessly coupling to a user device, receiving information from the user device and information regarding one or more operating parameters of a golf vehicle, controlling the display to provide one or more indications regarding the operating parameters in the first sub-graphical user interface and access to one or more applications associated with the user device in the second sub-graphical user interface, receiving a user input regarding operation of the golf vehicle, and operating the golf vehicle according to the user input.

Still another embodiment relates to a recreational vehicle. The recreational vehicle includes a chassis, a body, a display to provide a graphical user interface. The graphical user interface includes a first sub-graphical user interface in a first section of the graphical user interface providing one or more indications regarding one or more parameters of the recreational vehicle, and a second sub-graphical user interface providing access to one or more applications associated with a user device connected to the recreational vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a schematic block diagram of a control system of the vehicle of FIG. 1, according to an exemplary embodiment.

FIG. 6-11 are various graphical user interfaces provided by a display of the control system of FIG. 5, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

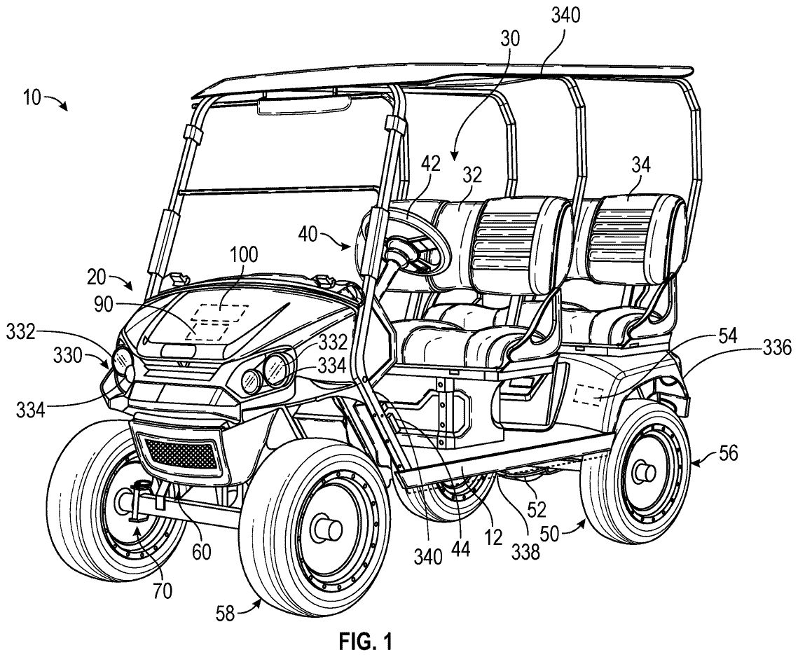

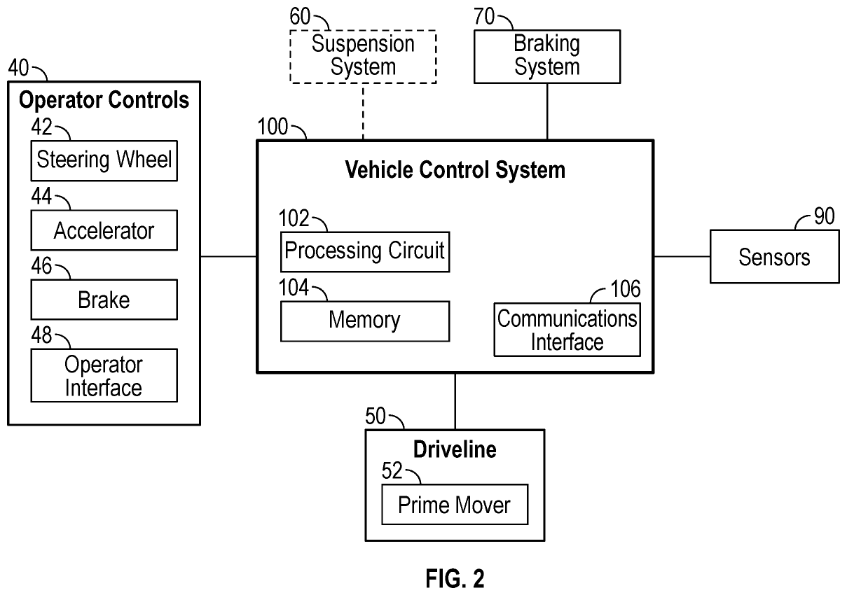

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle.

In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, another type of chore product that may be used on a golf course, a ground support equipment (“GSE”) that may be used at an airport, and/or still other off-road machines or vehicles.

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 has a plurality of operating modes. The prime mover 52 and/or the transmission device are configured to facilitate changing between the plurality of operating modes of the driveline 50. In some embodiments, the plurality of operating modes of the driveline 50 include a forward mode where the driveline 50 drives at least one of the rear tractive assembly 56 and/or the front tractive assembly 58 forward, thereby propelling the vehicle 10 forward; a neutral mode where the driveline 50 does not drive the rear tractive assembly 56 or the front tractive assembly 58; and a reverse mode where the driveline 50 drives the rear tractive assembly 56 and/or the front tractive assembly 58 backward, thereby propelling the vehicle 10 backward.

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

As shown in FIG. 1, the vehicle 10 includes a plurality of lights, shown as vehicle lights 330, variously positioned around the chassis 12, the body 20, and/or within the occupant area 30. More specifically, the vehicle lights 330 include (a) one or more first exterior lights, shown as headlights 332 and daytime running lights 334, positioned at a front end of the vehicle 10; (b) one or more second exterior lights, shown as taillights 336, positioned at a rear end of the vehicle 10; (c) one or more third exterior lights, shown as underglow lights 338, positioned underneath the vehicle 10; and (d) one or more interior lights, shown as interior lights 340, positioned to illuminate at least a portion of the occupant seating area 30. The interior lights 340 may include (a) at least one of footwell light positioned to illuminate at least one footwell of the occupant seating area 30 or at least one overhead light (e.g., on a canopy of the vehicle 10) positioned to illuminate the occupant seating area 30 from above. According to an exemplary embodiment, the headlights 332 and the daytime running lights 334 are positioned to illuminate an area proximate the front end of the vehicle 10, the taillights 336 are positioned to illuminate an area proximate the rear end of the vehicle 10, the underglow lights 338 are positioned to illuminate an area underneath the vehicle 10, and the interior lights 340 are positioned to illuminate one or more portions of the occupant seating area 30. In some embodiments, the headlights 332, the daytime running lights 334, the taillights 336, and the interior lights 340 are coupled to the body 20. In some embodiments, the underglow lights 338 and the interior lights 340 are coupled to the frame 12. According to an exemplary embodiment, the vehicle lights 330 a first one or a first set of lights and a second one or second set of lights of the vehicle lights 330 are independently operable (e.g., one being on while the other is off, one being a first color while the other is a second color, etc.).

### Electrified Driveline

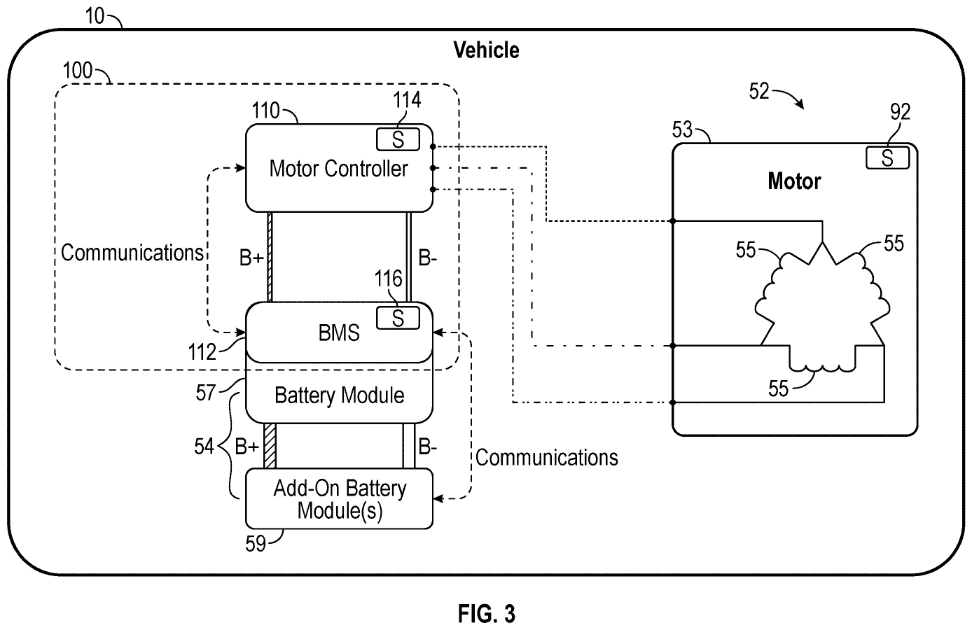

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

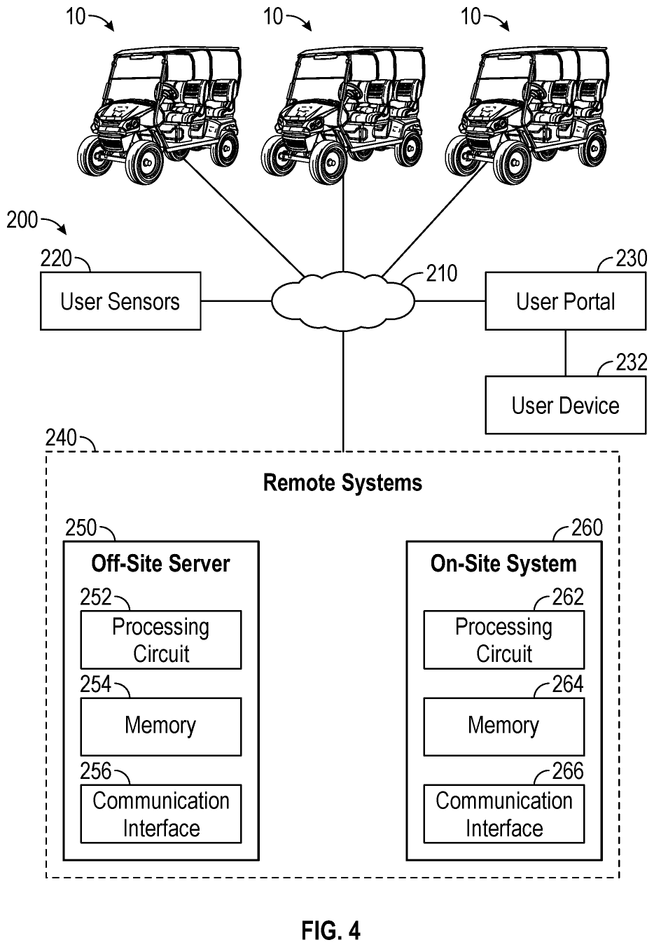

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Display

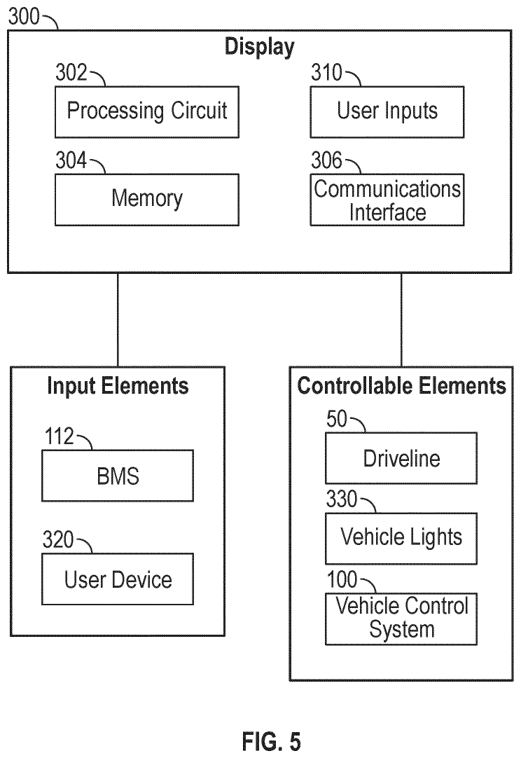

As shown in FIG. 5-11, the operator interface 48 of the vehicle 10 includes a display device, shown as display 300. As shown in FIG. 5, the display 300 includes a processing circuit 302, a memory 304, a communications interface 306, and user inputs 310. In some embodiments, the communications interface 306 is configured to facilitate a wired and/or wireless connection between the display 300 and various other components of the vehicle 10 and/or external devices. In some embodiments, the communications interface 306 facilitates communication between the display 300 and other components of the vehicle 10 and/or external devices using one or more communication protocols (e.g., wired, Bluetooth, Wi-Fi, NFC, etc.).

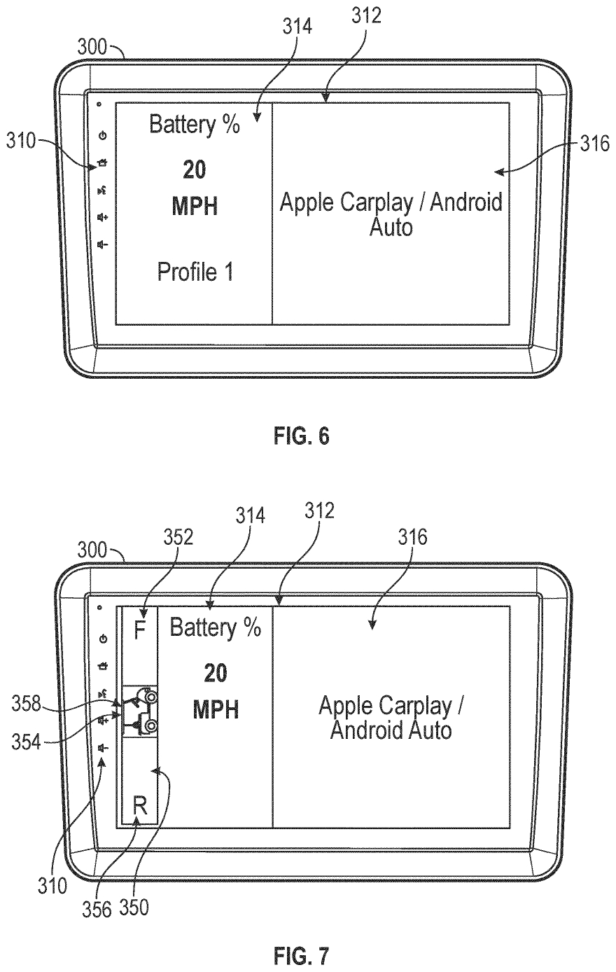

As shown in FIG. 6-11, the user inputs 310 include a plurality of buttons configured to facilitate operation of the display 300 and/or other components of the vehicle 10. The user inputs 310 may be or include physical buttons along an edge of the display 300 (e.g., the left edge as shown in FIG. 6-11, along a right edge, along a top edge, along a bottom edge, etc.).

According to an exemplary embodiment, the display 300 is communicably and operably coupled to various input elements. As shown in FIG. 5, the input elements include the BMS 112 and an external device, shown as user device 320. The user device 320 may be the same as or similar to the user device 232. The display 300 is configured to receive information from the input elements. In some embodiments, the display 300 receives information regarding the SOC of the battery system via the BMS 112. In some embodiments, the display 300 couples with the user device 320 using a wireless connection such that the display 300 can access one or more applications associated with the user device 320.

According to an exemplary embodiment, the user device 320 is a portable device of the operator of the vehicle 10 (e.g., a smartphone). Upon being coupled with the display 300, one or more applications associated with the user device 320 is accessible via the display 300.

As shown in FIG. 5, the display 300 is operably and communicably coupled with a number of controllable elements. According to an exemplary embodiment, the controllable elements include the driveline 50, the vehicle control system 100, and the vehicle lights 330 (e.g., the headlights 332, the daytime running lights 334, the taillights 336, the underglow lights 338, the interior lights 340, etc.). The display 300 is coupled with each of the controllable elements such that the display 300 can receive information indicative of the operation of each of the controllable elements and modify the operation thereof.

According to an exemplary embodiment, the user inputs 310 include a plurality of control elements configured to be operated by the operator to control and operate various components of the display 300 and other components of the vehicle 10. For example, the user inputs 310 may include a power button, a home button, a speech button, a volume increase button, a volume decrease button, and/or other suitable buttons. The user inputs 310 are configured to receive an input from the operator and alter the operation of one or more components of the vehicle 10 and/or the display 300.

As shown in FIG. 6-11, the display 300 is configured to provide a graphical user interface 312. In some embodiments, the graphical user interface 312 of the display 300 includes a number of graphical control elements configured to receive user inputs to operate various components of the vehicle 10. In some embodiments, the display 300 includes a touchscreen to receive one or more touch inputs from the operator to operate one or more components of the vehicle 10. In some embodiments, the graphical user interface 312 is provided to the operator at the touchscreen of the display 310. As shown in FIG. 6-11, the graphical user interface 312 includes a first sub-graphical user interface 314 positioned in a first section (e.g., a left portion or section) of the graphical user interface 312 and a second sub-graphical user interface in a second section (e.g., a right portion or section) of the graphical user interface 312. As shown in FIGS. 6-11, the display 300 is configured to provide the first sub-graphical user interface 314 in the first section of the graphical user interface 312 and the second sub-graphical user interface 316 in the second section of the graphical user interface 312 at the same time.

According to an exemplary embodiment, the first sub-graphical user interface 314 and the second sub-graphical user interface 316 have different sizes. As shown in FIG. 6-11, the first sub-graphical user interface 314 is smaller (e.g., narrower) than the second sub-graphical user interface 316. More specifically, the first sub-graphical user interface 314 is displayed in the left section of the graphical user interface 312 and is smaller than the second sub-graphical user interface 316 displayed in the right section of the graphical user interface 312. That is, the first section of the graphical user interface 312 is proximate a left side of the graphical user interface 312 and includes the first sub-graphical user interface 314, and the second section of the graphical user interface 312 is proximate a right side of the graphical user interface 312 and includes the second sub-graphical user interface 316. In some embodiments, the first sub-graphical user interface 314 is larger (e.g., wider) than the second sub-graphical user interface 316. In some embodiments, the first sub-graphical user interface 314 is positioned in the right section and the second sub-graphical user interface 316 is positioned in the left section of the graphical user interface 312.

According to an exemplary embodiment, the display 300 is configured to receive information indicative of the SOC of the energy storage 54 from the input elements. By way of example, the display 300 may receive the SOC of the energy storage 54 via the BMS 112. Upon receiving the SOC from the BMS 112 by, for example, the communications interface 306, the display 300 displays the SOC of the energy storage 54 in the first sub-graphical user interface 314. As shown in FIG. 6-10, the SOC is provided proximate the top of the first sub-graphical user interface 314.

According to an exemplary embodiment, the display 300 is configured to receive information indicative of a speed of the vehicle 10 from the vehicle control system 100 via one or more of the sensors 90. By way of example, the display 300 may receive the vehicle speed from the vehicle control system 100 and provide an indication of the vehicle speed to the operator in the first sub-graphical user interface 314. As shown in FIG. 6-10s, the vehicle speed indication is provided in the middle of the first sub-graphical user interface 314, beneath the SOC.

As shown in FIG. 6-11, the display 300 is configured to provide access to the one or more applications associated with the user device 320 in the second sub-graphical user interface 316. By way of example, the user device 320 may be or include a smartphone of the operator, with the display 300 configured to provide access to the one or more applications associated with the user device 320 via the second sub-graphical user interface 316. In some embodiments, the one or more applications associated with the user device 320 may be or include Apple CarPlay and/or Android Auto. According to an exemplary embodiment, the second sub-graphical user interface 316 is configured to mirror the one or more applications associated with the user device 320 and be operable to control the functions of the one or more applications associated with the user device 320. By way of example, the second sub-graphical user interface 316 may mirror the one or more applications associated with the user device 320, including each graphical control element of the one or more applications that, when acted on by the operator, operate the one or more applications and the user device 320 according to the action of the operator, just as the application would on the user device 320. That is, the second sub-graphical user interface 316 is configured to receive user inputs regarding the operation of the one or more applications associated with the user device 320. According to an exemplary embodiment, the second sub-graphical user interface 316 of the graphical user interface 312 is configured to receive a touch input from the operator via the touchscreen of the display 300, the touch input indicating a desired operation to be conducted in the one or more applications associated with the user device 320.

For example, the vehicle control system 100 and/or the display 300 may be configured to (a) wirelessly couple with the user device 320, (b) acquire information regarding one or more operating parameters of the vehicle 10, (c) control the display 300 to provide the first sub-graphical user interface 314 in the first section of the graphical user interface 312 where the first sub-graphical user interface 314 (i) provides one or more indications regarding the one or more operating parameters of the vehicle 10 and/or (ii) provides the operator with the ability to provide user inputs to adjust settings of the vehicle 10, and (d) control the display 300 to provide the second sub-graphical user interface 316 at the same time as the first sub-graphical user interface 314 where the second sub-graphical user interface 316 provides access to the one or more applications associated with the user device 320. The vehicle control system 100 is configured to receive the user inputs from the operator via the display 300 to facilitate user adjustment of the settings and operate components of the vehicle 10 according to the user inputs. The user inputs received by the vehicle control system 100 may be or include a user input indicating a desired mode of operation of the various modes of operation of the driveline 50, the function of a respective light of the vehicle 10, and/or an operation to be conducted by the one or more applications associated with the user device 320.

In some embodiments, the vehicle control system 100 is configured to receive one or more user inputs via the display 300 indicative of the respective operating mode of the driveline 50, acquire information regarding the function of the vehicle lights 330, and control the display 300 to provide the first sub-graphical user interface 314 in the first section of the graphical user interface 312 where the first sub-graphical user interface 314 provides one or more indications regarding the operating mode of the driveline 50 and one or more indications regarding the function of the vehicle lights 330.

According to an exemplary embodiment, the display 300 is configured to display the first sub-graphical user interface 314 and the second sub-graphical user interface 316 at the same time where the first sub-graphical user interface 314 displays a plurality of operating parameters of the vehicle 10 and the second sub-graphical user interface 316 provides operator access to the one or more applications associated with the user device 320. In some embodiments, the operating parameters of the vehicle 10 displayed in the first sub-graphical user interface 314 include one or more of the operating mode of the driveline 50 of the vehicle 10, the SOC of the battery system of the vehicle 10, a current speed of the vehicle 10, and/or operating data regarding the vehicle lights 330. That is, the operating parameters of the vehicle 10 include a current state of charge regarding the energy storage 54, a current speed of the vehicle 10, a current operating mode of the driveline 50, and a current status of the vehicle lights 330, among other possible operating parameters.

According to an exemplary embodiment, the graphical user interface 312 is configured to display the plurality of operating modes of the driveline 50. As shown in FIG. 7-11, the graphical user interface 312 includes a selector, shown as operating mode selector 350. The operating mode selector 350 is a graphical component of the graphical user interface 312 configured to display the plurality of operating modes of the driveline 50. In some embodiments and as shown in FIG. 7-9 and 11, the operating mode selector 350 is positioned along a vertical edge of the display 300. That is, the operating mode selector 350 can be positioned at a left-most or right-most position on the display 300, and extend from the top of the graphical user interface 312 to the bottom of the graphical user interface 312. For example, the operating mode selector 350 may be positioned along a vertical edge of the display 300 with a mode selector or slider (e.g., slider 358) repositionable along the vertical edge of the display 300.

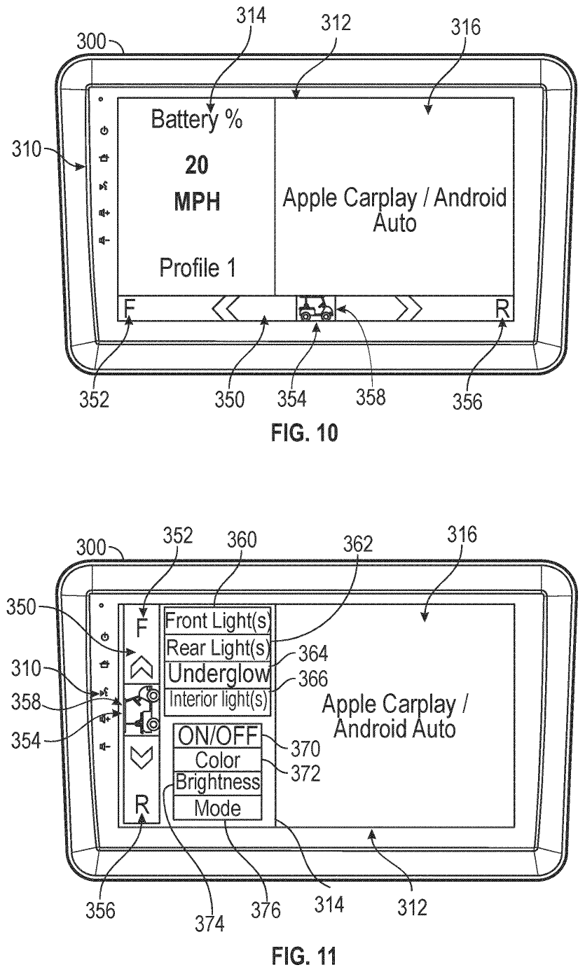

In some embodiments and as shown in FIG. 10, the operating mode selector 350 is positioned along a horizontal edge of the display. That is, the operating mode selector 350 can be positioned at a bottom-most or top-most position on the display 300, and extend from the left end of the graphical user interface 312 to the right end of the graphical user interface 312. For example, the operating mode selector 350 may be positioned along a horizontal edge of the display 300 with a mode selector or slider (e.g., slider 358)repositionable along the horizontal edge of the display 300.

In some embodiments, the operating mode selector 350 is or includes a slider configured to be moved between a plurality of positions associated with various operating modes of the driveline 50. That is, the operating mode selector 350 can include a slider configured to be moved by the operator to select the desired operating mode of the driveline 50. In some embodiments, the operating mode selector 350 is or includes a number of user interface elements to be toggled to select the desired operating mode of the driveline 50. For example, the operating mode selector 350 can include a number of buttons configured to receive a user input to operate the operating mode selector 350 to select the desired operating mode of the driveline 50. In another example, the operating mode selector 350 may include a number of toggle switches configured to be switched on and off to select the desired operating mode of the driveline 50.

In some embodiments, the vehicle 10 includes a physical gear selector configured to facilitate selecting the desired operating mode of the driveline 50. For example, if the display 300 is off, the operating mode selector 350 may be inaccessible, meaning the operator must use a different method to change the operating mode of the driveline 50. In this manner, the operator can operate the physical gear selector to select the operating mode of the driveline 50.

As shown in FIG. 7-11, the operating mode selector 350 includes various operating mode indicators representing respective operating modes of the driveline 50, including a forward mode indicator 352, a neutral mode indicator 354, and a reverse mode indicator 356. That is, the graphical user interface 312 includes a plurality of indicators representing the plurality of operating modes of the driveline 50. The forward mode indicator 352 represents the forward mode of the driveline 50, where the driveline 50 drives tractive elements of the vehicle 10 forward. That is, the plurality of indicators includes a first indication of the forward mode of the driveline 50. The neutral mode indicator 354 represents the neutral mode of the driveline 50, where the driveline 50 does not drive the tractive elements of the vehicle 10. That is, the plurality of indicators includes a second indication of the neutral mode of the driveline 50. The reverse mode indicator 356 represents the reverse mode of the driveline 50, where the driveline 50 drives the tractive elements backward. That is, the plurality of indicators includes a third indication of the reverse mode of the driveline 50. The forward mode indicator 352, the neutral mode indicator 354, and the reverse mode indicator 356 provide the operator with an indication of the current operating mode of the driveline 50 and an indication of each of the plurality of operating modes of the driveline 50.

As shown in FIG. 7-11, the operating mode selector 350 includes a graphical control element, shown as slider 358. The slider 358 is repositionable along the operating mode selector 350 between the positions associated with the forward mode indicator 352, the neutral mode indicator 354, and the reverse mode indicator 356. In some embodiments, the slider 358 is movable by the operator by the display 300 receiving a touch input provided to a touch screen of the display 300 and moving the slider 358. That is, the operator may touch and move the slider 358 along the operating mode selector 350 to select the respective operating mode of the driveline 50. For example, the slider 358 is repositionable about the display 300, within, for example, the operating mode selector 350, between a plurality of positions associated with the plurality of operating modes of the driveline 50 to provide a visual indication of the respective operating mode of the driveline 50.

According to an exemplary embodiment, the slider 358 includes a graphical representation of the vehicle 10. That is, the slider 358 includes a graphical representation of the vehicle 10 and is repositionable about the display 300, within, for example, the operating mode selector 350. In some embodiments, as shown in FIGS. 10 and 11, the operating mode selector 350 includes arrow keys to facilitate changing the position of the slider 358 to select the respective operating mode of the driveline 50. That is, the operator may touch the arrow keys on the touchscreen of the display 300 to move the slider 358 about the operating mode selector 350 to select the respective operating mode of the driveline 50. In some embodiments, the position of the slider 358 provides a visual indication of the respective operating mode of the driveline 50. That is, the position of the slider 358 relative to at least one of the forward mode indicator 352, the neutral mode indicator 354, or the reverse mode indicator 356 provides a visual indication of the respective operating mode of the driveline 50. For example, the slider 358 may be positioned at the forward mode indicator 352, visually indicating to the operator that the respective operating mode of the driveline 50 is the forward mode.

According to an exemplary embodiment, the position of the slider 358 causes the driveline 50 to operate according to the position of the slider 358. That is, the position of the slider 358 controls the operating mode of the driveline 50. For example, the display 300 may receive a touch input from the operator positioning the slider 358 at one of the forward mode indicator 352, the neutral mode indicator 354, or the reverse mode indicator 356. Responsive to the slider 358 being positioned at one of the forward mode indicator 352, the neutral mode indicator 354, or the reverse mode indicator 356, the vehicle control system 100 will determine the respective operating mode of the driveline 50 based on the position of the slider 358 on the display 300. Responsive to determining the respective operating mode of the driveline 50, the vehicle control system 100 will cause the driveline 50 to operate according to the respective operating mode indicated by the position of the slider 358 on the display 300. That is, receiving a user input indicative of a selection of a respective operating mode of the driveline 50 includes receiving a touch input from the operator via the touchscreen of the display 300.

According to an exemplary embodiment, operating the driveline 50 according to the respective operating mode includes switching the respective operating mode from a first operating mode to a second operating mode. For example, if the slider 358 is positioned at the forward mode indicator 352 and the first operating mode is the forward mode, the operator may reposition the slider 358 from the forward mode indicator 352 to the neutral mode indicator 354, thereby making the neutral mode the second operating mode. In this manner, the respective operating mode of the driveline 50 is changed from the forward mode (i.e., the first operating mode) to the neutral mode (i.e., the second operating mode).

As shown in FIG. 7, the slider 358 is positioned at the neutral mode indicator 354. The neutral mode indicator 354 indicates that the respective mode of the driveline 50 is the neutral mode. The position of the slider 358 at the neutral mode indicator 354 causes the driveline 50 to operate according to the respective operating mode associated with the neutral mode indicator 354 (i.e., the neutral mode). While the slider 358 is positioned at the neutral mode indicator 354, the display 300 will send signals to the vehicle control system 100 indicating that the respective operating mode of the driveline 50 is the neutral mode, as visually indicated by the position of the slider 358 at the neutral mode indicator 354, thereby causing the driveline 50 to operate in the neutral mode.

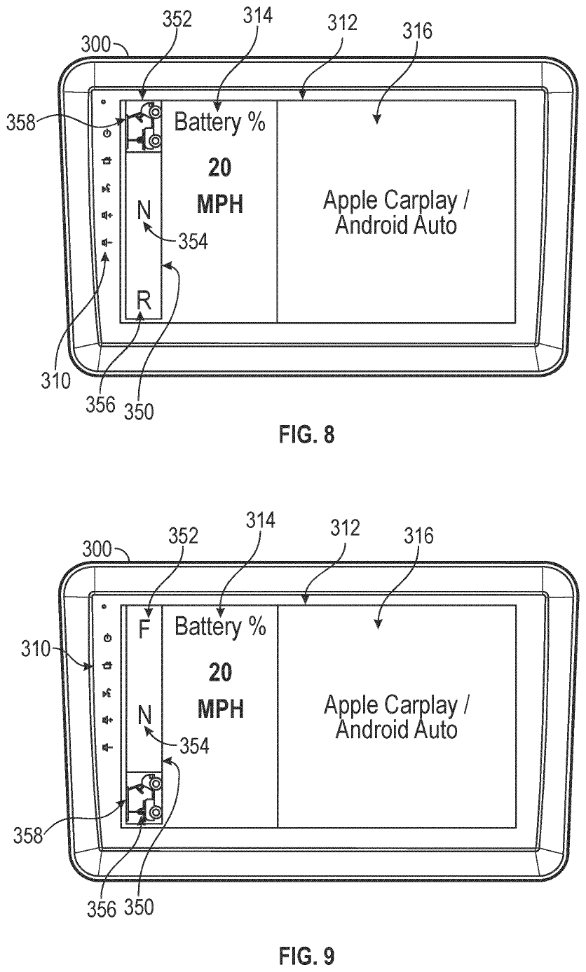

As shown in FIG. 8, the slider 358 is positioned at the forward mode indicator 352. The forward mode indicator 352 indicates that the respective operating mode of the driveline 50 is the forward mode. The position of the slider 358 at the forward mode indicator 352 causes the driveline 50 to operate according to the respective operating mode associated with the forward mode indicator 352 (i.e., the forward mode). While the slider 358 is positioned at the forward mode indicator 352, the display 300 will send signals to the vehicle control system 100 indicating that the respective operating mode of the driveline 50 is the forward mode, as visually indicated by the position of the slider 358 at the forward mode indicator 352, thereby causing the driveline 50 to operate in the forward mode.

As shown in FIG. 9, the slider 358 is positioned at the reverse mode indicator 356. The reverse mode indicator 356 indicates that the respective operating mode of the driveline 50 is the reverse mode. The position of the slider 358 at the reverse mode indicator 356 causes the driveline 50 to operate according to the respective operating mode associated with the reverse mode indicator 356 (i.e., the reverse mode). While the slider 358 is positioned at the reverse mode indicator 356, the display 300 will send signals to the vehicle control system 100 indicating that the respective operating mode of the driveline 50 is the reverse mode, as visually indicated by the position of the slider 358 at the reverse mode indicator 356, thereby causing the driveline 50 to operate in the reverse mode.

As shown in FIG. 10, the operating mode selector 350 is along a horizontal edge of the display 300 and includes arrow keys to facilitate repositioning the slider 358 about the operating mode selector 350, between the operating mode indicators (i.e., the forward mode indicator 352, the neutral mode indicator 354, and the reverse mode indicator 356). In some embodiments, upon receiving a touch input from the operator at the arrow keys, the display 300 will move the slider 358 left or right, towards at least one of the forward mode indicator 352, the neutral mode indicator 354, or the reverse mode indicator 356, according to the input received at the arrow keys, determine the respective operating mode of the driveline 50, send signals to the vehicle control system 100 indicative of the respective operating mode of the driveline 50, and cause the driveline 50 to operate according to the position of the slider 358.

As shown in FIG. 11, the operating mode selector 350 is along a vertical edge of the display 300 and includes arrow keys to facilitate repositioning the slider 358 about the operating mode selector 350, between the operating mode indicators. In some embodiments, upon receiving a touch input from the operator at the arrow keys, the display 300 will move the slider 358 up or down, towards at least one of the operating mode indicators, according to the input received at the arrow keys, determine the respective operating mode of the driveline 50, send signals to the vehicle control system 100 indicative of the respective operating mode of the driveline 50, and cause the driveline 50 to operate according to the position of the slider 358.

As shown in FIG. 11, the first sub-graphical user interface 314 includes a number of graphical control elements associated with the vehicle lights 330. According to an exemplary embodiment, the vehicle control system 100 is configured to wirelessly couple with or couple with a wired connection to at least one of the vehicle lights 330, such that the display 300 can exchange information with the vehicle lights 330 regarding the function and operation of the vehicle lights 330. That is, the display 300 may couple with the vehicle lights 330 such that the display 300 can send and receive information with the vehicle lights 330. In some embodiments, receiving the information indicative of the function of the respective light includes sending and receiving signals via a wireless connection. In some embodiments, receiving the information indicative of the function of the respective light includes sending and receiving signals via a wired connection. Responsive to coupling with the vehicle lights 330, the vehicle control system 100 may operate the display 300 and the graphical user interface 312 to provide the operator with information regarding the vehicle lights 330 in the first sub-graphical user interface 314. For example, the vehicle control system 100 may be configured to acquire information regarding a function of each of the vehicle lights 330, control the display 300 to provide the graphical user interface 312 displaying the information regarding the function of each of the vehicle lights 330, receive a user input via the display 300 regarding the function of at least one of the vehicle lights 330, and operate the at least one of the vehicle lights 330 according to the user input.

In some embodiments, the vehicle control system 100 communicably and operably couples with one or more of the vehicle lights 330 via Bluetooth® or another short-range communication protocol. Responsive to the vehicle control system 100 being coupled to the vehicle lights 330, the vehicle control system 100 determines the functions of each of the vehicle lights 330 and what functions of the vehicle lights 330 that can be controlled. That is, the vehicle control system 100 can determine the available functions of the vehicle lights 330 and how to control the vehicle lights 330 via one or more Bluetooth® signals. In some embodiments, the vehicle control system 100 determines control functions associated with each of the vehicle lights 330. The control functions associated with each of the vehicle lights 330 are based on the determined functions of the vehicle lights 330 and what functions of the vehicle lights 330 that can be controlled. The control functions of the vehicle lights 330 may be or include a status function configured to turn a respective one or more of the vehicle lights 330 on and off, a color function configured to change the color of the respective one or more of the vehicle lights 330, a brightness function configured to increase or decrease the brightness of the respective one or more of the vehicle lights 330, a mode function configured to change a mode of the respective one or more of the vehicle lights 330 (e.g., solid light, strobe or flash, pattern, etc.), and the like. In some embodiments, the vehicle control system 100 operates the display 300 to provide an indication of each of the vehicle lights 330 and the functions thereof.

In some embodiments, the connection (e.g., wireless, wired, etc.) between the vehicle control system 100 and the vehicle lights 330 allows the vehicle control system 100 and/or the display 300 to receive information regarding the vehicle lights 330 such as the position of each of the vehicle lights 330, the current operating status (e.g., on/off) of each of the vehicle lights 330, the current brightness of the vehicle lights 330, the current mode of the vehicle lights 330, and the like. In some embodiments, the information received by the display 300 regarding the vehicle lights 330 includes capabilities of the vehicle lights 330. For example, the information may include the color capabilities for each of the vehicle lights 330, the brightness capabilities of each of the vehicle lights 330, the various modes of each of the vehicle lights 330, and the like. According to an exemplary embodiment, the display 300 is configured to display all of the control functions of the vehicle lights 330 responsive to being coupled with the vehicle lights 330 and determining the control functions.

In some embodiments, the operator can change the name of each of the vehicle lights 330 coupled to the display 300. For example, the display 300 may include a settings menu configured to modify settings of the display 300 and other components of the vehicle 10. In this manner, the display 300 can receive a number of operator inputs to open the settings menu, select a respective one of the vehicle lights 330, and rename the respective one of the vehicle lights 330.

As shown in FIG. 11, the information regarding the vehicle lights 330 displayed in the first sub-graphical user interface 314 includes a number of graphical control elements associated with each of the vehicle lights 330. As shown, the graphical control elements associated with the vehicle lights 330 may include first graphical control elements and second graphical control elements.

In some embodiments, the first graphical control elements include a number of graphical control elements configured to facilitate selecting a respective light form the vehicle lights 330. As shown in FIG. 11, the first graphical control elements include a front light(s) control element 360, a rear light(s) control element 362, an underglow control element 364, and an interior light(s) control element 366. The front light(s) control element 360 corresponds to the headlights 332 and/or the daytime running lights 334. The rear light(s) control element 362 corresponds to the taillights 336. The underglow control element 364 corresponds to the underglow lights 338. The interior light(s) control element 366 corresponds to the interior lights 340. According to an exemplary embodiment, the first graphical control elements include a graphical control element for each of the front lights of the vehicle lights 330, the rear lights of the vehicle lights 330, the underglow lights of the vehicle lights 330, and the interior lights of the vehicle lights 330. Each of the front light control element 360, the rear light control element 362, the underglow control element 364, and the interior light control element 366 are configured to receive a touch input via the touchscreen of the display 300. In some embodiments, the input received by the front light control element 360, the rear light control element 362, the underglow control element 364, or the interior light control element 366 is a selection of a respective light of the vehicle lights 330. For example, the operator may touch the front light control element 360 to select at least one of the headlights 332 or the daytime running lights 334, the rear light control element 362 to select the taillights 336, the underglow control element 364 to select the underglow lights 338, and the interior light control element 366 to select the interior lights 340.

In some embodiments, the second graphical control elements include a number of graphical control elements configured to facilitate adjusting the function of the respective light selected via the first graphical control elements. In some embodiments, the second graphical control elements appear following selection of one of the first graphical control elements. In some embodiments, adjusting the function of the respective light may be or include changing one or more functions of the respective light from a current function to a desired function. In some embodiments, each of the second graphical control elements are selectable control elements configured to receive a touch input via the touchscreen of the display 300. As shown in FIG. 11, the second graphical control elements include a ON/OFF control element 370, a color control element 372, a brightness control element 374, and a mode control element 376.

The ON/OFF control element 370 is a status selectable control element configured to adjust a status of the respective light. That is, the ON/OFF control element 370 is configured to turn the respective light on and off. For example, if the taillights 336 are off, the display 300 may receive a first user input at the first graphical control elements selecting the rear light control element 362, the display 300 may then receive a second user input at the ON/OFF control element 370. Responsive to receiving the second user input at the ON/OFF control element 370 via the touchscreen of the display 300, the vehicle control system 100 may turn on the taillights 336.

The color control element 372 is a color selectable control element configured to control a color of the respective light. That is, the color control element 372 is configured to change the color of the respective light. For example, an operator may provide a first user input to the display 300 at the underglow control element 364 and thereafter provide a second user input to the display 300 at the color control element 372. Responsive to receiving the second user input at the color control element 372 via the touchscreen of the display 300, the vehicle control system 100 may change the color of the underglow lights 338.

The brightness control element 374 is a brightness selectable control element configured to control a brightness of the respective light. That is, the brightness control element 374 in configured to control a brightness of the respective light. For example, the operator may provide a first user input at the interior light control element 366 and thereafter provide a second user input to the brightness control element 374. Responsive to receiving the second user input at the brightness control element 374 via the touchscreen of the display 300, the vehicle control system 100 may change the brightness of the interior lights 340.

The mode control element 376 is a selectable control element configured to control a mode of the respective light. That is, the mode control element 376 is configured to adjust a mode of the respective light. For example, the operator may provide a first user input at the underglow control element 364 of the first graphical control elements, and thereafter provide a second user input at the mode control element 376. Responsive to receiving the second user input at the mode control element 376 via the touchscreen of the display 300, the vehicle control system 100 may change the mode of the underglow lights 338 (e.g., from a solid/constant underglow to a flashing or strobing underglow).

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf vehicle comprising:
a chassis;
a body coupled to the chassis;
a plurality of tractive elements coupled to the chassis;
a driveline configured to drive at least one of the plurality of tractive elements;
a display; and
a control system configured to:
control the display to provide a graphical user interface displaying a plurality of operating modes of the driveline;
receive a user input via the display indicative of a selection of a respective operating mode of the plurality of operating modes; and
operate the driveline according to the respective operating mode.

2. The golf vehicle of claim 1, wherein the plurality of operating modes include:
a forward mode where the driveline drives the tractive elements forward;
a neutral mode where the driveline does not drive the tractive elements; and
a reverse mode where the driveline drives the tractive elements backward.

3. The golf vehicle of claim 1, wherein the display is configured to receive the user input via a touchscreen of the display.

4. The golf vehicle of claim 1, wherein the graphical user interface includes a graphical control element that is repositionable about the display between a plurality of positions associated with the plurality of operating modes of the driveline to provide a visual indication of the respective operating mode of the driveline.

5. The golf vehicle of claim 4, wherein the graphical control element includes a graphical representation of the golf vehicle that is repositionable about the display.

6. The golf vehicle of claim 4, wherein the graphical control element is repositionable along a vertical edge of the display.

7. The golf vehicle of claim 4, wherein the graphical control element is repositionable along a horizontal edge of the display.

8. The golf vehicle of claim 4, wherein the graphical user interface includes arrow keys to facilitate changing the position of the graphical control element to select the respective operating mode of the driveline.

9. The golf vehicle of claim 1, wherein the graphical user interface includes a plurality of indicators representing the plurality of operating modes of the driveline.

10. The golf vehicle of claim 1, further comprising a plurality of lights coupled to at least one of the chassis or the body, wherein the control system is configured to:
acquire information regarding a function of each of the plurality of lights;
control the display to provide a graphical user interface displaying the information regarding the function of each of the plurality of lights;
receive a user input via the display regarding the function of at least one of the plurality of lights; and
operate the at least one of the plurality of lights according to the user input.

11. The golf vehicle of claim 1, wherein the control system is configured to:
wirelessly couple with a user device;
acquire information regarding one or more operating parameters of the golf vehicle;
control the display to provide a first sub-graphical user interface in a first section of the graphical user interface, the first sub-graphical user interface providing one or more indications regarding the one or more operating parameters of the golf vehicle and providing a user with the ability to adjust settings of the golf vehicle; and
control the display to provide a second sub-graphical user interface in a second section of the graphical user interface at the same time as the first sub-graphical user interface, the second sub-graphical user interface providing access to one or more applications associated with the user device.

12. The golf vehicle of claim 1, further comprising a plurality of lights coupled to at least one of the chassis or the body, wherein the control system is configured to:
wirelessly couple with a user device;
acquire information regarding one or more operating parameters of the golf vehicle including a function of each of the plurality of lights;
control the display to provide a first sub-graphical user interface in a first section of the graphical user interface, the first sub-graphical user interface providing one or more indications regarding the one or more operating parameters of the golf vehicle and providing a user with the ability to adjust settings of the golf vehicle;
control the display to provide a second sub-graphical user interface in a second section of the graphical user interface at the same time as the first sub-graphical user interface, the second sub-graphical user interface providing access to one or more applications associated with the user device;
receive a user input via the display regarding the function of at least one of the plurality of lights; and
operate the at least one of the plurality of lights according to the user input.

13. A method comprising:
providing, by a display, a graphical user interface displaying a plurality of operating modes of a driveline;
receiving, by the display, a user input indicative of a selection of a respective operating mode of the driveline;
controlling, by a control system, the display to indicate the selection of the respective operating mode; and
operating, by the control system, the driveline according to the respective operating mode.

14. The method of claim 13, wherein receiving the user input includes receiving a touch input from a user via a touchscreen of the display.

15. The method of claim 13, wherein operating the driveline according to the respective operating mode includes switching the respective operating mode from a first operating mode to a second operating mode.

16. The method of claim 13, wherein receiving the user input includes:
receiving, by a graphical control element along an edge of the display, a user input, wherein the graphical control element includes:
a plurality of indicators representing the plurality of operating modes of the driveline; and
a graphical representation of a golf vehicle that is repositionable about the plurality of indicators to select the respective operating mode of the driveline.

17. The method of claim 16, wherein the graphical user interface of the display includes arrow keys to facilitate changing the position of the graphical representation of the golf vehicle to select the respective operating mode of the driveline.

18. A recreational vehicle comprising:
a chassis;
a body coupled to the chassis;
a plurality of tractive elements coupled to the chassis;
a driveline configured to drive at least one of the tractive elements; and
a display configured to provide a graphical user interface, the graphical user interface including:
a plurality of indicators positioned along an edge of the display, the plurality of indicators providing a visual indication of a plurality of modes of the driveline;
a graphical control element repositionable between the plurality of indicators;
a first sub-graphical user interface in a first section of the graphical user interface, the first sub-graphical user interface providing an indication of one or more parameters of the recreational vehicle; and
a second sub-graphical user interface in a second section of the graphical user interface, the second sub-graphical user interface providing access to one or more applications associated with a user device connected to the recreational vehicle.

19. The recreational vehicle of claim 18, wherein the plurality of indicators include:
a first indication of a forward mode of the driveline;
a second indication of a neutral mode of the driveline; and
a third indication of a reverse mode of the driveline.

20. The recreational vehicle of claim 18, wherein the graphical control element includes a graphical representation of the recreational vehicle.

21-60. (canceled)
